(19) United States
(12) Patent Application Publication
(10) Pub. No.: US 2022/0301258 A1
(43) Pub. Date: Sep. 22, 2022

(54) Rotated Rectangular Bounding Box Annotation Method

(71) Applicant: CHINA INSTITUTE OF WATER RESOURCES AND HYDROPOWER RESEARCH, BEIJING (CN)

(72) Inventors: Wenlong SONG, BEIJING (CN); Changjun LIU, BEIJING (CN); Tao SUN, BEIJING (CN); Rui TANG, BEIJING (CN); Yuanyuan FU, BEIJING (CN); Yizhu LU, BEIJING (CN); Lang YU, BEIJING (CN); Jie LIU, BEIJING (CN); Yue WANG, BEIJING (CN)

(21) Appl. No.: 17/826,049

(22) Filed: May 26, 2022

Related U.S. Application Data
(63) Continuation of application No. PCT/CN2021/105454, filed on Jul. 9, 2021.

(30) Foreign Application Priority Data
Jul. 10, 2020 (CN) 202010660705.1

(51) Int. Cl. G06T 15/10

(52) U.S. Cl. CPC G06T 15/10; G06T 2210/12

(57) ABSTRACT

Disclosed in the present invention is An improved rotated rectangular bounding box annotation method, used for taking as anchor boxes samples annotation and bounding box output at predicting of a target detection and tracking algorithm, wherein: coordinates of a central point C, a vector \vec{CD} from the coordinates of the central point C to any one vertex D, and a proportional coefficient of a vector \vec{CP} of a vector \vec{CE} on the vector \vec{CD} from the coordinates of the central point C to an adjacent vertex E of the vertex D, and a vector \vec{CD}; external constraints to be met: the vector \vec{CP} is in the same direction as the vector \vec{CD}, and the included angle from the vector \vec{CD} to the vector \vec{CE} is one of a clockwise direction or a counterclockwise direction; representation of an annotation vector \vec{CD}: the angle between the component of the annotation vector recorded at the first position and the vector is clockwise (or counterclockwise), and the value range of this angle is [0,90) degrees; the modulus value or another component of the annotation vector are recorded at the second position; the direction of the first component of the annotation vector is recorded at the third position, and this direction can be taken as X-axis direction or Y-axis direction; when the bounding box is square, either X-axis direction or Y-axis direction it can be taken. When the square bounding box and the general rectangular bounding box share the same constraints, recognition of the constraint by a machine learning algorithm is facilitated.

### CROSS-REFERENCE TO RELATED APPLICATIONS

This application is a continuation of International Application No. PCT/CN2021/105454, filed on Jul. 9, 2021, which claims priority to Chinese Patent Application No. 202010660705.1, filed on Jul. 10, 2020. The above applications are hereby incorporated by reference in their entireties.

### TECHNICAL FIELD

The present invention provides an improved rotated rectangular bounding box annotation method for object detection and tracking algorithms in computer vision, especially for supervised-learning-based object detection and tracking algorithms. This rectangular bounding box annotation method can be used for taking as anchor boxes samples annotation and bounding box output at predicting.

### BACKGROUND ART

Bounding box annotation is very important of object detection in images Object detection has been widely used in many areas, such as pedestrian detection, face detection, foreground detection in video surveillance, motion tracking, behavior recognition and analysis. In general, object detection is based on supervised learning, thus requires many sample images with objects in them be annotated by bounding boxes and class labels. For example, gradient direction histograms (HOG), deformable component models (DPM), and Convolutional Neural Networks (CNN), etc.

There has been a method to annotate rotated bounding box (see FIG. 2) in paper Bounding Box Projection for Regression Uncertainty in Oriented Object Detection (DOI:10.1109/ACCESS.2021.3072402), and the elements for annotation are as follows: 1) coordinates of the center point C, 2) a vector \vec{CD} formed by the center point C and a chosen vertex D, and 3) cosine of a angle (∠DCE) formed by center point to the chosen vertex D and its close neighbor vertex E, i.e. the ratio of the vector \vec{CP} to vector \vec{CD}, where CP is the projection of the vector \vec{CE} to \vec{CD}, and \vec{CE} is a vector formed by the center of the bounding box to one of the vertex E that close neighbor to vertex D. The chosen vertex D has four candidates, and every vertex has two close neighbors. This means every Bounding Box has eight representations. To make a none-square bounding box has only one numerical representation, they add two constraints: 1) the vector \vec{CP} is in the same direction as the vector \vec{CD} (i.e. the angle ∠DCE doesn't greater than 90 degree or less than 0), 2) the vertex E in either of the clockwise or counterclockwise direction of the vertex D. With these two constraints, there left two choices of the vertex D for none-square bounding box, and they are in diagonal position. When denoting the two choices of the vertex with D and D′, then it is easy to known that vector \vec{CD} is equal to the opposite of vector \vec{CD}′, that is \vec{CD}=−\vec{CD′}. If a vector lies in the first or third quadrant, its two coordinate values are all positive or all negative respectively; otherwise the two coordinate values are one positive and one negative. Hereinafter, we will say whether the two coordinate values have same sign or not. They introduce a binary value a to indicate whether the two coordinate values of a vector have same sign (α=1) or not (α=0). When a vector lies in axis, a is indifferent. Then notation (|u|, |v|, α) can represents the vector \vec{CD} and its inverse vector −\vec{CD} at once, where and |v| denote the magnitude of the two coordinate values of the vectors. When the two components are of the same sign, the vector \vec{CD} and −\vec{CD} are (u, v) and (−u, −v) respectively; when the two components are not of the same sign, the vector \vec{CD} and −\vec{CD} are (−u, v) and (u, −v) respectively. Then the algebraic representation of the method can be set to (x_{c}, y_{c}, |u|, |v|, α, ρ), wherein (x_{c}, y_{c}) is the coordinates of the center point C, (|u|, |v|, α) represents the vector \vec{CD} and −\vec{CD}, and ρ is cosine of the angle ∠DCE.

Of this annotation method, the same non-square rectangular bounding box has only one numerical representation. Only one numerical representation means that a bounding box in two-dimensional space only corresponds to a unique set of numerical values (x_{c}, y_{c}, |u|, |v|, α, ρ), any change in the set of numerical values corresponding to a different bounding box. For example, for the rotated bounding box annotation method of recording the coordinates of central point, width, height and rotation angle, when 2kπ+π/2 is added to or subtracted from the rotation angle, it still represents the same bounding box. And this is a case where the same bounding box has multiple numerical representations.

However, the same square bounding box still has two numerical representations of the above annotation method. Because, for a square bounding box, all four vertexes can satisfy the method's constraints to form the vector \vec{CD}. The difference between these representations means inconsistent loss of bounding box regression, which adds difficulties to training. To ensure the uniqueness of the bounding box representation, they additionally constrain the angle between \vec{CD} and X-axis in the range of [0,90), which implies D can only appear in the first/forth quadrant and X-axis. However, as the external constraints of square rectangles and non-square rectangles are not exactly the same, machine learning algorithms have difficulties to identify the external constraints.

### SUMMARY OF THE INVENTION

A goal of the present invention is to avoid the above-mentioned technical problem that the external constraints to achieve uniqueness of the bounding box representation of square rectangles and non-square rectangles are not exactly the same. And on the basis of the above-mentioned technical problem, a new method for representing the vector (previously represented by \vec{CD} and −\vec{CD}, hereinafter referred to as the annotation vector) formed by the center point (C) and a chosen vertex (D), thereby achieving a new rotated rectangular bounding box annotation method. This method makes the square bounding box and the general rectangular bounding box satisfy a bounding box has only one numerical representation under the same external constraints.

In order to achieve the above goal, the technical solution of the present invention is to provide an improved rotated rectangular bounding box annotation method, used for taking as anchor boxes samples annotation and bounding box output at predicting of a target detection and tracking algorithm, wherein

the elements for annotation being:

the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D;

the external constraints to be met being that:

the vector \vec{CP} is in the same direction as the vector \vec{CD}, the vertex E in either of the clockwise or counterclockwise direction of the vertex D;

the representation of the annotation vector \vec{CD}:

is an ordered triple wherein the first element is one of the axis-aligned component of the annotation vector that the component is in either of the clockwise or counterclockwise direction to the annotation vector and the angle between the component and the annotation vector is in the range of [0,90), the second element is the modulus value or the other axis-aligned component of the annotation vector, and the third elements is the first element's direction which can be in X-axis direction or Y-axis direction or both;

when the bounding box is square, the first element's direction can be in both X-axis direction and Y-axis direction.

Advantageous effects of the present invention is that it solves the problem of needing extra constraints to make square bounding box has only one numerical representation. When the square bounding box and the general rectangular bounding box share the same constraints, recognition of the constraint by a machine learning algorithm is facilitated.

Hereinafter, the present invention will be described in detail with reference to the accompanying drawings and examples.

### BRIEF DESCRIPTION OF THE DRAWINGS

FIG. 1 is a schematic diagram showing a square bounding box annotation method;

FIG. 2 is a schematic diagram showing a rectangular bounding box annotation method in the background art.

### DETAILED DESCRIPTION OF THE INVENTION

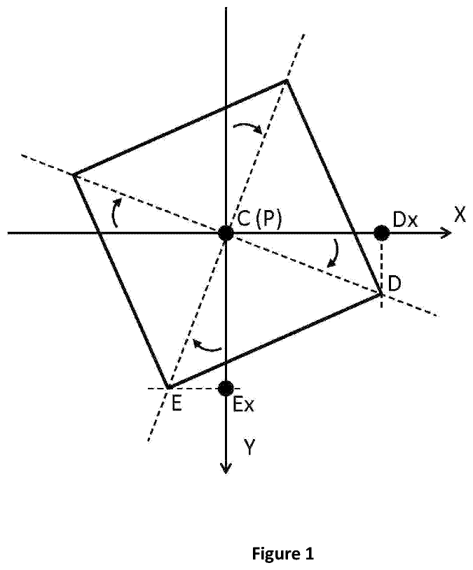

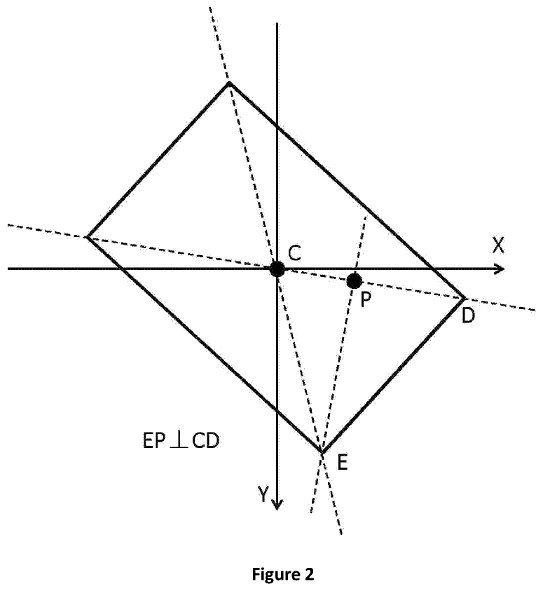

In FIG. 1, X represents coordinate axis in an image row direction, Y represents the coordinate axis in an image column direction, C represents a center point of the bounding box (where the projection point P of \vec{CE} on \vec{CD} is also provided herein), D, E are some two vertexes of the bounding box, Dx represents the projection point of \vec{CD} on the X axis, and Ex represents the projection point of \vec{CE} on the Y axis. It can be seen that the direction of rotation of from \vec{CDx} to \vec{CD} is the same as the direction of rotation of from \vec{CEx} to \vec{CE}, and \vec{CDx} and \vec{CEx} are of the same length. In FIG. 2, X represents the coordinate axis in the image row direction, Y represents the coordinate axis in the image column direction, C represents the center point of the bounding box, D and E are some two vertexes of the bounding box, and P is the projection point of \vec{CE} on the \vec{CD}.

An improved rotated rectangular bounding box annotation method used for taking as anchor boxes samples annotation and bounding box output at predicting of a target detection and tracking algorithm, wherein

the elements for annotation being:

the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D;

the external constraints to be met being that:

the vector \vec{CP} is in the same direction as the vector \vec{CD}, the vertex E in either of the clockwise or counterclockwise direction of the vertex D;

the representation of the annotation vector \vec{CD}:

is an ordered triple wherein the first element is one of the axis-aligned component of the annotation vector that the component is in either of the clockwise or counterclockwise direction to the annotation vector and the angle between the component and the annotation vector is in the range of [0,90), the second element is the modulus value or the other axis-aligned component of the annotation vector, and the third elements is the first element's direction which can be in X-axis direction or Y-axis direction or both;

when the bounding box is square, the first element's direction can be in both X-axis direction and Y-axis direction; besides, the elements arrangements in the triple are not limited to the above-mentioned order.

Wherein ordered triple of the annotation vector \vec{CD} can be flexibly arranged, that is to say, the annotation vector can be represented as

(d, |u|, |v|), (d, |v|, |u|), (|v|, d, |u|), (|v|, |u|, d), (|v|, d, |u|),
wherein u represents one of the axis-aligned component of the annotation vector, d represents the direction of the component u, and v represents the other component of the annotation vector or the modulus of the annotation vector.
The aforementioned order to arrange the elements of the annotation vector can used for taking as anchor boxes samples annotation and bounding box output at predicting of the object detection and tracking algorithm, and the elements arrangements in the triple are not limited to the above-mentioned order.

The following is a further description of the above discussion.

For a square bounding box, a given constraint can be satisfied by choosing one vertex as the quantities for annotation, i.e., the annotation vector can be \vec{CD}, \vec{CE}, −\vec{CD}, −\vec{CE}. As shown in FIG. 1: the only difference between the vector \vec{CD} of a central point C to a certain vertex D and the vector \vec{CE} of an adjacent vertex E of C to D is that the positions of the two coordinate values are interchanged and that one coordinate value is the opposite of each other, that is, if the coordinate of \vec{CD} is (u, v), then the coordinate of \vec{CE} is (−v, u). If there is a design that can make representation of \vec{CD}, \vec{CE}, −\vec{CD}, −\vec{CE} possible at the same time, it can be realized that the square annotation box and the general rectangular annotation box satisfy a target box with only one numerical representation under the same external constraint.

The vectors are regarded as the sum of two components along the coordinate axis, it can be seen that in the two components of the vector with the same coordinate value (\vec{CD} in FIG. 1), the angle to the vector is the clockwise component on the X axis, and in the two components of the vector with the different coordinate value (\vec{CE} in FIG. 1), the angle to the vector is the clockwise component on the Y axis. If the component of which the angle to the annotation vector is clockwise is recorded at the first position; then the first component of the vector of the same sign of the two coordinate values is on the X-axis and the first component of the vector of the opposite sign of the two coordinate values is on the Y-axis. For a square bounding box, it is possible to use a vector (\vec{CD} in FIG. 1) with the same sign of two coordinate values or a vector (\vec{CE} in FIG. 1) with opposite sign of two coordinate values to mark; that is, the first component may be on either the X or Y axis. It is easy to see that with this annotation, the modulus of the first component of the two annotation vectors of the square range is identical.

Therefore, under the condition that the external constraint specified in the background art is satisfied, it is additionally specified that the included angle from the component of the annotation vector recorded at the first position to the vector is in a clockwise (or counterclockwise) direction and the included angle has a value range of [0,90) degrees; then another component can be recorded at the second position and the direction of the first component is recorded at the third position. The direction in which the first component is located may be taken to be the X-axis direction or the Y-axis direction, and may be taken to be either the X-axis direction or the Y-axis direction when the bounding box is square. Since the annotation vectors are pairs of opposing vectors, each component simply records a modulus value. The algebraic representation of the finally annotation vector is (|u|, |v|, d), where |u| is the modulus of the first component of the annotation vector, |v| is the modulus of the second component, and d is the direction of the first component.

The two components of the aforementioned annotation vector and the recording positions of the directions may be arranged flexibly, for example, the direction of a component whose angle to the annotation vector is clockwise (or counterclockwise) direction may be recorded at a first position, the modulus value of this component may be recorded at a second position, and the modulus value of another component may be recorded at a third position. With this arrangement of record locations, the algebraic representation of the annotation vector is (d, |u|, |v|).

If, let d= [symbol] 1,0 [symbol] represents that the first component is on the X axis, d= [symbol] 0,1 [symbol] represents that the first component is on the Y axis, d= [symbol] 1,1 [symbol] represents that the first component can be either on the X axis or on the Y axis; then \vec{CD}, \vec{CE}, −\vec{CD}, −\vec{CE} in FIG. 1 are (|u|, |v|, [symbol] 1,0 [symbol] ), (|u|, −|v|, [symbol] 0,1 [symbol] ), (−|u|, −|v|, [symbol] 1,0 [symbol] ), (−|u|, |v|, [symbol] 0,1 [symbol] ), respectively. When it is specified that the angle between the component recorded on the first position of annotation vector and the vector is clockwise and the value range of this angle is [0,90) degrees, (|u|, |v|, [symbol] 1,1 [symbol] ) can simultaneously represent \vec{CD}, \vec{CE}, −\vec{CD}, −\vec{CE}.

The foregoing ranges of included angles have been agreed to [0,90) degrees in order to avoid multiple numerical representations of square bounding boxes where all four vertexes are on coordinate axes. Under this convention, the included angle is less than 90 degrees, and the modulus of the component recorded at the first position is greater than zero for a square with four vertexes all on the coordinate axis, which reduces the numerical representation to one.

In the second position of the annotation vector representation method provided in the present embodiment, instead of recording the modulus of the second component, the modulus value of the annotation vector may be recorded. In this case, the coordinates of the annotation vector may also be solved under the given convention. Therefore, even if the position of the recorded value is adjusted or different values are recorded at different positions, it does not constitute a different technical solution as long as the annotation vector is recorded using the external convention provided by the present invention.

The present embodiment is not limited to the following preferred embodiments, and any person skilled in the art should be aware of the structural changes made under the inspiration of the present invention, and any technical solution having the same or similar technical features as the present invention falls within the scope of the present invention.

Preferred embodiments thereof are: when annotating the sample image, the value of x_{c}, y_{c}, u, v is normalized according to the maximum value of image width (wᵢ) and height (hᵢ). Then the corresponding value of the target bounding box in the annotated document is x_{c}/max(wᵢ, hᵢ), y_{c}/max(wᵢ, hᵢ), |u|/max(wᵢ, hᵢ), |v|/max(wᵢ, hᵢ), d, ρ.

1. An improved rotated rectangular bounding box annotation method used for taking as anchor boxes samples annotation and bounding box output at predicting of a target detection and tracking algorithm, wherein:
the elements for annotation being:
the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D;
the external constraints to be met being that:
the vector \vec{CP} is in the same direction as the vector \vec{CD}, the vertex E in either of the clockwise or counterclockwise direction of the vertex D;
the representation of the annotation vector \vec{CD}:
is an ordered triple wherein the first element is one of the axis-aligned component of the annotation vector that the component is in either of the clockwise or counterclockwise direction to the annotation vector and the angle between the component and the annotation vector is in the range of [0,90), the second element is the modulus value or the other axis-aligned component of the annotation vector, and the third elements is the first element's direction which can be in X-axis direction or Y-axis direction or both;
when the bounding box is square, the first element's direction can be in both X-axis direction and Y-axis direction; besides, the elements arrangements in the triple are not limited to the above-mentioned order.
